(19) United States
(12) Patent Application Publication
(10) Pub. No.: US 2008/0083334 A1
(43) Pub. Date: Apr. 10, 2008

(54) Method and system for removing ash from a filter

(76) Inventors: Pronob Bardhan, Corning, NY (US); Weiguo Miao, Corning, NY (US); Joseph James St. Angelo, Campbell, NY (US); Benjamin Allen Stevens, Painted Post, NY (US)

Correspondence Address: CORNING INCORPORATED, SP-TI-3-1, CORNING, NY, 14831, US

(21) Appl. No.: 11/544,264

(22) Filed: Oct. 6, 2006

(51) Int. Cl. B01D 46/04

(52) U.S. Cl. 95/281; 96/233

(57) ABSTRACT

This invention is directed to a method and system for removing ash, particularly a heat-treated ash deposit from a filter. At least a majority (e.g., greater than 50 wt %) of the ash is removed as a result of the process. The filter containing the ash deposit is contacted with an acid composition to remove a majority of the ash, and the acid-contacted filter is then treated to remove at least a portion of the acid.

### BACKGROUND OF THE INVENTION

1. Field of the Invention

This invention relates to a method and system for removing ash from a filter. In particular, this invention relates to a method and system for removing a heat-treated ash deposit from an exhaust filter.

2. Technical Background

Particulate filters are used to remove particulates such as soot and ash from exhaust systems, particularly engine exhaust systems. In general, soot that collects on the filter can be removed from the filter through regeneration, which is essentially carried out by heating or burning the soot that has been collected in the filter. Ash, however, is a non-combustible particulate material, and cannot be removed from the filter simply by regeneration. As ash deposit builds, the filter becomes less effective due to a resulting increase in back-pressure.

U.S. Patent Publication No. 2006/0070360 discloses a system for removing particulate deposits from a filtering device. The disclosed system includes a gas pressurization assembly that is removably connectable to the filtering device and includes a plurality of orifices. The orifices are positioned on the filter surface so as to direct a flow beyond at least one blocking apparatus of the filtering device. The system also includes a matter collection assembly removably connectable to the filtering device.

U.S. Pat. No. 7,025,811 is directed to a cleaning device for cleaning diesel particulate filters. The device comprises a source of high pressure fluid and means to transport the fluid to a nozzle or nozzles; an actuator for moving the nozzles; a controller with logic for instructing the actuator to automatically move the nozzle or nozzles across the surface of the filter; a collection device and suction device downstream of the filter; and ducting to transport the fluid between parts of the system. A second collection device is used downstream of the suction device to provide additional particulate removal. The system cleans particulate material from the filter by rotating the filter and rotating a jet about an axis outside of the filter; moving a nozzle in two perpendicular directions (i.e., x-y); and rotating a rectangular nozzle about the central axis of the filter.

U.S. Pat. No. 7,047,731 discloses a method for reducing diesel contaminant and additive particulate matter in an internal combustion engine particulate filter. The method involves entraining contaminant and additive particulate matter in an active, pulsating positive pressure fluid stream flowing in a direction opposite a fluid flow direction through an installed particulate filter during normal operation. The fluid stream is flowed while applying a negative pressure to the installed filter.

U.S. Patent Publication No. 2005/0011357 discloses a system for flushing ash from a diesel particulate filter. The system includes a conduit for supplying a fluid from a fluid supply to an outlet of a diesel particulate filter. A pump slowly reverse flows the fluid through the diesel particulate filter, and an acoustic wave source generates an acoustic wave, such as an ultrasonic wave, through the fluid in the diesel particulate filter to assist in dislodging the ash from the diesel particulate filter, while the fluid carries the ash out the inlet of the diesel particulate filter. The ash may be filtered from the fluid after the fluid exits the diesel particulate filter, so that the fluid may be reused.

The particular systems for removing ash particulate matter are not fully effective in removing ash deposit, particularly a heat-treated ash deposit. It would therefore, be beneficial to reduce or eliminate the ash deposit so that such filters can be more effectively used.

### SUMMARY OF THE INVENTION

This invention provides a method and system for removing ash deposits from filters. The method and system are particularly effective in removing heat-treated ash deposit from particulate filters.

According to this invention, an ash deposit on a filter, for example a particulate filter, can be removed using an acid wash. In one embodiment of the invention, there is provided a method for removing ash from a filter that includes the steps of providing a particulate filter having ash deposited thereon; and contacting the filter containing the ash deposit with an acid composition to remove at least a portion of the ash from the filter. The acid-contacted filter is preferably treated, more preferably by water treating, to remove at least a portion of the acid from the filter.

In one embodiment, the acid composition has a pH of less than or equal to 3. Preferably, the acid-contacted filter is treated by rinsing with a solution to remove at least a portion of the acid and thereby neutralize the filter.

In another embodiment, the ash deposited on the filter is a heat-treated deposit. In a particular embodiment, the ash deposited on the filter is a heat-treated deposit that has been heated at a temperature of at least 700° C.

In one embodiment of the invention, the acid composition includes at least one organic or inorganic acid. Preferably, the acid composition contacts the ash deposited filter at a total volume of acid composition to filter of from 0.1:1 to 3:1. It is also preferred that the acid composition contacts the ash deposited filter for not more than one hour.

In another embodiment, the filter is a ceramic filter. Preferably, the ceramic filter is comprised of at least one component selected from the group consisting of cordierite, mullite, alumina, zirconium phosphate, silicon carbide, silicon nitride and aluminum titanate.

In yet another embodiment, the treated or water rinsed filter is dried following rinsing. Optionally, the ash deposited filter is contacted with vapor to remove at least a portion of ash contained on the ash deposited filter prior to contacting with the acid composition.

In a particular embodiment, the filter containing the ash deposit is provided from an exhaust housing of a diesel engine system. The filter containing the ash deposit is preferably provided from an exhaust housing of a diesel engine system after 100,000 miles of operation.

According to another aspect of the invention, there is provided a system for removing ash from a filter. Preferably, the system includes an acid container for containing an acid composition; a pump and injection line connected to the acid container; a housing to hold the filter; a nozzle extending from the injection line and into the housing, and apertured to spray the acid composition over the filter contained in the housing; and a collection line for removing the acid solution from the housing. In one embodiment, the nozzle includes a rotating head.

### BRIEF DESCRIPTION OF THE DRAWINGS

Examples of various embodiments of this invention are shown in the attached Figures, wherein:

FIG. 1 is one example of a system that can be used to remove ash from a filter;

FIG. 2 is a sectional view of the housing used in FIG. 1;

FIG. 3 is one embodiment of a housing that is connected to an air compressor and a vacuum unit;

FIG. 4 is a graph showing the results of an example in which ash-coated filters were baked at different temperatures and cleaned with air and water to determine the effectiveness of the air cleaning methodology on filter performance; and

FIG. 5 is a graph showing the effectiveness of cleaning an ash coated filter using a nitric acid solution compared against distilled water.

### DETAILED DESCRIPTION OF THE INVENTION

This invention is directed to a method and system for removing ash and/or soot from a filter. The method and system are particularly beneficial in that they enable non-combustible particulate deposits such as ash to be effectively removed from a filter provided with or containing such ash. At least a portion, preferably a majority (e.g., greater than 50 wt %) of the ash is removed as a result of the process. More preferably, at least 75 wt % is removed, still more preferably at least 90 wt %, and most preferably at least 98 wt % of the ash is removed.

In general, the filter containing the ash deposit is contacted with an acid-containing composition to remove a majority of the ash. The acid-contacted filter is then treated to remove at least a portion of the acid.

The method of this invention can be used to remove ash and/or soot from any filter, filtering device, or other matter collection device capable of withstanding acid treatment. For example, the method can be practiced on filters from diesel, gasoline, natural gas, or other combustion engines or furnaces. Additional examples of the types of filters that can be used according to the method of this invention include filters from coal power plants and/or other types of power plants. Thus, the method of this invention can be used in conjunction with filters that can be found on any work machine, on-road vehicle, off-road vehicle, stationary machine, and/or other exhaust-producing machines.

The system of this invention can be used to remove ash and/or soot from filters while the filter or filters are on the machine or for separate cleaning of the filter when removed from the machine. In one embodiment, the filter is removed from the machine and treated to remove the soot and/or ash.

The filter that is to be treated according to this invention is provided with at least a deposit of ash. Ash is considered to be the deposit that remains after complete combustion of a fuel. This material is, therefore, considered incombustible.

Besides the carbon mixed with the ash, there are other non-carbon elements that are present. These non-carbon elements are present in the ash since the fuel source typically contains other elements besides carbon and hydrogen. The non-carbon elements can add to the problematic nature of having an ash deposit build on a filter. For example, fuel from combustion engines or furnaces will often contain sulfur, nitrogen, phosphorous, and other elements that are naturally present in the fuel. Combustion engine fuel such as gasoline and diesel fuel will typically contain additives to aid in combustion, reduce engine wear, engine stress, etc., during the combustion process. In addition, lubricating oil will also leak into the engine during combustion and this lubricating oil will contain additional additives.

Elements that can be included in the ash deposit comprise at least one of K, Na, Al, Ca, Cr, Cu, Fe, Mg, Mn, Mo, Ni, P, Si, Zn, and Zr. Particularly problematic elements in the ash deposit include at least one of Na, Al, Ca, Fe, Mg, P, Si, and Zn. Even more problematic elements in the ash deposit include at least one of Ca, Fe, P, and Zn.

In typical operation, filters, especially particulate filters, are used at the exhaust end of an engine or furnace to capture soot and/or ash particles that emerge from the exhaust. Soot is considered to be carbon particles or dust caused by incomplete combustion. Therefore, at least a portion of the material contained in the ash can be combustible. On a relative basis, soot deposit is easier to remove from a filter than ash.

When a filter containing soot becomes sufficiently hot, at least a portion of the soot particulate will combust. At relatively high combustion temperatures, ash deposits in the filter will agglomerate into a hard substance. This hard substance is very difficult if not impossible to remove using air or water as cleaning agents. However, this substance can be effectively removed by the process or system of this invention.

The method and system of this invention are particularly effective in removing a heat-treated ash deposit that has been heated at a temperature of at least 700° C. A heat-treated ash deposit that has been heated at a temperature of at least 800° C. or at least 900° C. can also be effectively removed.

In one embodiment of the invention, the filter containing the ash deposit is provided from an exhaust housing of a gasoline or diesel engine system. Preferably, the ash deposit is provided from an exhaust housing of a diesel engine system.

The more extensive the use, the greater the build-up of ash deposit on the filter. Preferably, the filter is removed from the exhaust housing after a predetermined interval of operation and treated according to the method or system of this invention. The predetermined interval can be based on pressure drop across the filter or some other calculable interval. For example, the filter in the exhaust housing of a moving machine can be provided for treating after some interval of movement. In one embodiment, the filter containing the ash deposit is provided from an exhaust housing of an engine system, preferably a diesel engine system, after 100,000 miles of operation. More preferably, the filter containing the ash deposit is provided from an exhaust housing of an engine system, preferably a diesel engine system, after 200,000 miles of operation, and most preferably, after 400,000 miles of operation.

The filter that is to be used in conjunction with the method of this invention or cleaned or treated with the system of this invention is preferably a particulate filter. The filter that is to be treated or cleaned has deposited thereon ash and, optionally, soot.

In one embodiment; the filter that is provided for treatment according to this invention is a ceramic filter. Preferably, the ceramic filter is comprised of at least one component, particularly a substrate component, selected from the group consisting of cordierite, mullite, alumina, zirconium phosphate, silicon carbide, silicon nitride and aluminum titanate.

In another embodiment of the invention, the filter that is provided to be treated according to this invention is a particulate filter that includes a monolith substrate. The monolithic substrate can have any shape or geometry suitable for a particular application and can be made of any one or more of the above noted materials. In one embodiment, the monolith substrate is a multicellular structure such as a honeycomb structure. Honeycombs are multicellular bodies having an inlet and outlet end or face, and a multiplicity of cells extending from the inlet end to the outlet end. The walls of the cells are porous. Generally honeycomb cell densities range from about 10 cells/in² (1.5 cells/cm²) to about 600 cells/in² (93 cells/cm²).

The monolithic substrate preferably has surfaces with pores which extend into the substrate. In one embodiment, at least a portion of the cells of the substrate at the inlet end or face is plugged. The plugging is preferably only at the ends of the cells. More preferably, the plugging is to a depth of about 7 to 13 mm. A portion of the cells on the outlet end but not corresponding to those on the inlet end are also preferably plugged. In such an embodiment, each cell is plugged only at one end. In one arrangement, every other cell on a given face is plugged as in a checkered pattern. This plugging configuration allows for more intimate contact between the exhaust stream and the porous wall of the substrate.

In a plugged type honeycomb filter, an exhaust stream flows into the substrate through the open cells at the inlet end, then through the porous cell walls, and out of the structure through the open cells at the outlet end. Filters of this type are typically referred to as a “wall flow” filters, since the flow paths resulting from alternate channel plugging require the fluid being treated to flow through the porous ceramic cell walls prior to exiting the filter. Cross flow structures can also be used.

The filters that are provided to be used in the method of this invention can also include a coating. In one embodiment, the coating is formed by “washcoating” a slurry of discrete-particles of the coating material onto the substrate. Other suitable methods include sol-gel coating, spray coating, and plasma coating.

Washcoating techniques involve forming a washcoating slurry of the coating material particles with various binder, e.g., alumina, zirconia, or silica, and then contacting the slurry with the monolith substrate. The washcoating slurry preferably has a viscosity of about 50-2000 cp. The average particle size of the coating material in the slurry is preferably about 0.5-40 micrometers, and more preferably about 0.5-5 micrometers. The contacting can be done any number of times to achieve the desired loading.

The resulting washcoated substrate is heat-treated to improve bonding between the substrate and the coating material. This is done by drying and calcining. The drying is done preferably under rotating conditions. The drying temperature is preferably about 25-200° C., and more preferably at about 50° C. for at least about 1 hour. Calcination is achieved at a temperature of 600-1100° C. with a hold at that temperature for up to 4 hours. The amount of washcoat on the substrate is preferably about 20 to 60 wt. % based on the total weight of the substrate and coating.

According to the method of this invention, a filter, particularly a particulate filter, is provided having ash deposited thereon. The filter is then treated by contacting with an acid composition to remove at least a portion, preferably a majority, of the ash from the filter. Preferably, the acid composition that is used to contact the filter has a pH of less than or equal to 3. More preferably, the acid composition has a pH of less than or equal to 2, and most preferably less than or equal to 1.

The acid composition includes at least one organic or inorganic acid. Examples of organic acids include at least one acid of the formula:

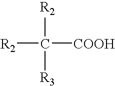

wherein R₁, R₂ and R₃ are, independently, H, alkyl or X, with X=F, Cl or Br. Preferably, at least one of R₁, R₂ and R₃ is X. Examples of other useful organic acids include benzenesulfonic acid and derivatives of benzenesulfonic acid.

Examples of inorganic acids useful in this invention include, but are not limited to, HNO₃, HCl, HF, HBr, H₂S, H₂SO₄, H₃PO₄, and mixtures thereof. In one embodiment, HNO₃ is included as an acid component.

The filter containing the ash deposit is contacted with the acid composition to remove at least a portion of the ash. The contact of the filter with the acid composition should not be for an extensive period in order to avoid acid damage to the filter. Preferably, the acid composition contacts the ash deposited filter for not more than one hour. More preferably, the acid composition contacts the ash deposited filter for not more than 30 minutes, still more preferably not more than 10 minutes, even more preferably not more than 5 minutes. Contacting the ash deposited filter with the acid composition for at least 30 seconds is preferred, more preferably for at least one minute.

The filter can be treated for ash removal in any manner practical. In one embodiment, the filter is removed from a housing in the exhaust system and the acid composition is sprayed or dropped or flowed over the filter. In another embodiment, the filter is immersed into the acid composition.

The amount of acid composition used to treat the filter need not be extensive. As understood in this invention, the acid composition comprises any acid compound and any diluent. The pH of the composition is the determining factor on the amount of the acid and diluent used. Therefore, the amount of acid composition includes the acid and any diluent that would be used to obtain the desired pH. In one embodiment, the acid composition contacts the ash deposited filter at a total volume of acid composition to filter volume of from 0.05:1 to 10:1, preferably from 0.075 to 5:1, more preferably 0.1:1 to 3:1, and most preferably 0.5:1 to 2:1. In cases of spraying or dropping or flowing the acid composition across or over the filter, the total volume of acid composition that is used can be substantially reduced by recycling the acid composition. For example, the acid composition can contact the ash deposited filter and the composition recycled to further contact the filter such that the acid composition contacts the ash deposited filter at the desired total volume of acid composition to filter volume.

Following contact with acid composition, it is preferable to treat the acid-contacted filter to remove at least a portion of the acid. Preferably, the treatment will also remove at least a portion of the ash along with the acid. In one embodiment, this treatment includes rinsing the acid-contacted filter. The rinse material used can be any material that neutralizes the acid component. For example any base can be used, as well as water. In one embodiment, the acid contacted filter is water rinsed to remove at least a portion of the acid from the acid contacted filter.

In one embodiment of the invention, the filter that has been treated to remove at least a portion of the acid is dried. Drying can be beneficial in that the cleaned and dried filter can be readily inserted back into the filter housing for immediate and more efficient use. In a particular embodiment, the acid treated filter is water rinsed, and the water rinsed filter is dried following rinsing.

The filter can be dried by any practical means. Examples of drying include flowing hot air through the filter, and placing the filter into a dryer.

A variety of optional steps can be included in the method of the invention. In one embodiment, the filter is regenerated prior to acid treatment. During regeneration, a heater or some other heat source is used to increase the temperature of the filter components. The heater increases the temperature of trapped particulate matter above its combustion temperature, thereby burning away the collected particulate matter and regenerating the filter while leaving behind additional ash. Although regeneration may reduce the buildup of soot in the filter, repeated regeneration of the filter typically results in a buildup of ash in the components of the filter over time and a corresponding deterioration in filter performance. Unlike soot, ash cannot be burned away through regeneration. Thus, the acid treatment preferably follows regeneration.

In another embodiment, soot or other material is blown off the filter prior to acid treatment. In particular, the ash deposited filter can be contacted with vapor to remove at least a portion of soot contained on the ash deposited filter prior to contacting with the acid composition. In one embodiment, the ash deposited filter that is provided is contacted with air at a flow rate of at least 300 ft³/min, preferably at least 600 ft³/min. The air is preferably supplied from an air source in which the air is contained at a pressure of at least 25 psi, preferably at least 50 psi, and more preferably at least 100 psi.

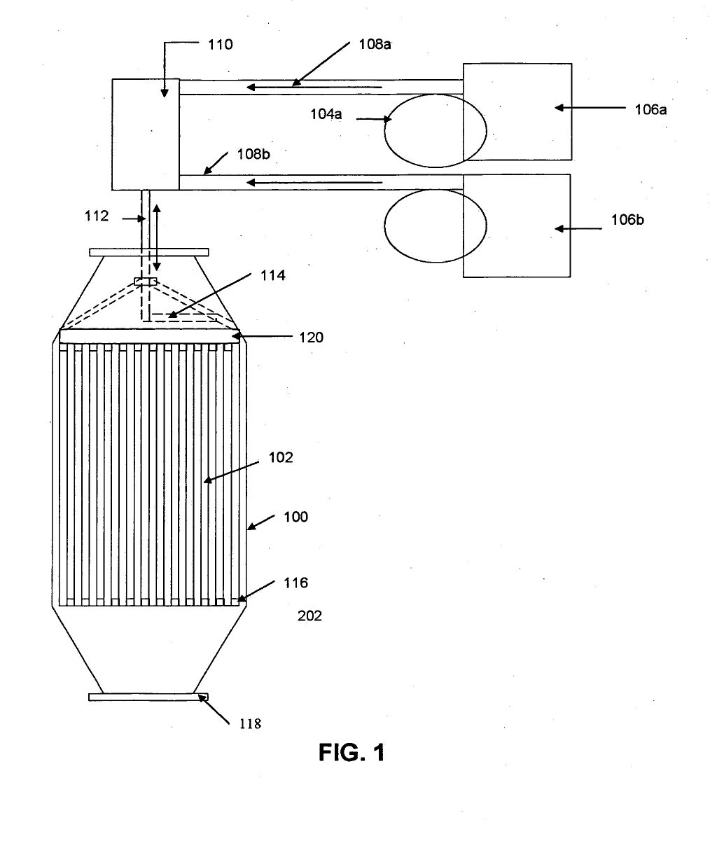

One example of a system that can be used to remove ash from a filter is shown in FIG. 1. As shown in FIG. 1, a housing 100 is used to contain a filter 102. The particular embodiment shown in FIG. 1 includes a pump 104a and a reservoir or container 106a for holding the acid composition, as well as a pump 104b and a reservoir or container 106b for holding a treating solution to neutralize the acid composition, preferably water.

In operation, the acid composition is pumped through line 108a and into header 110. From the header 110, the acid composition is sent through a tube 112 that extends at an angle over the filter 102 and through a nozzle 114. The acid composition passes through the open channels of the filter 102 and in a downward direction through the filter 102. The acid composition passes around the plugged portions 116 of the filter 102 and out through the outlet 118 of the housing 100 and on through a collection line or tube (not shown).

Following application of the acid composition, neutralizing fluid, i.e., water, is pumped through the line 108b and into the header 110. From the header 110, the water is sent through the tube 112 and through the nozzle 114, which acts like a rotating head. In this embodiment, the nozzle 114 is shown substantially parallel to the end of the filter and is located a relatively short distance from the surface of the filter. The water, like the acid composition, passes through the open channels of the filter 102 and in a downward direction through the filter 102. The water further passes around the plugged portions 116 of the filter 112 and out through the outlet 118 of the housing 100 and on through the collection line.

The housing 100 also contains an inflatable seal 120. The inflatable seal 120 is an O-ring type seal and is inflated after the filter is loaded into the housing 100 and the housing closed.

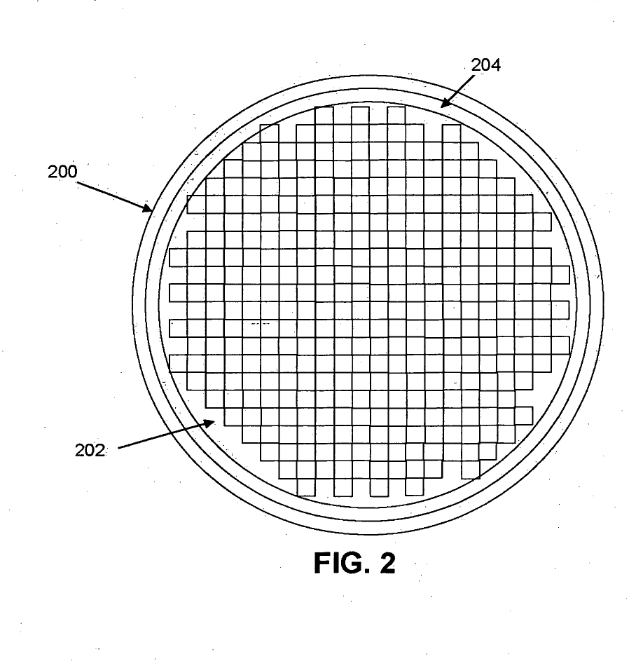

FIG. 2 shows a section view of the housing 200 and filter 202. A mat 204 is located between the filter 202 and the housing 200. The mat 204 prevents the filter 202 from contacting the housing 200, as well as provides mechanical support and thermal insulation.

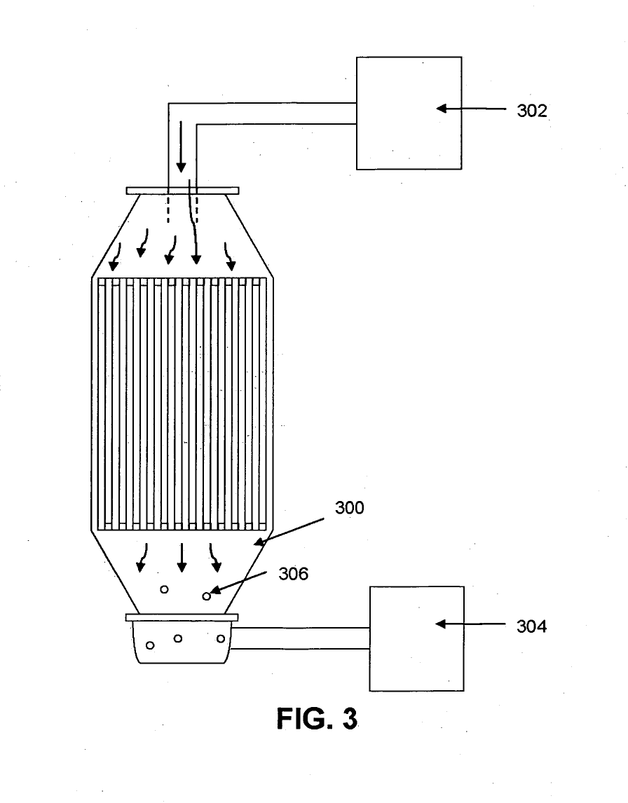

FIG. 3 shows an embodiment in which an air compressor 302 and a vacuum unit 304 are connected to housing 300. This optional embodiment can be used to remove some of the ash and more easily removable particles from the filter prior to acid treatment.

In operation, air is blown through the housing 300 at sufficient velocity and force to dislodge particles 306. The particles 306 are then collected in vacuum 304. Following air treatment, the housing 300 can be attached to a pump and reservoir type arrangement to apply the acid composition and neutralization fluid. For example, the housing can be attached to the embodiment of FIG. 1 or separate pumps and reservoirs can be attached if desired.

### EXAMPLE 1

Ash was obtained from Detroit Diesel Company, which had the composition shown in Table 1.

TABLE 1

| Element | Source of Element | Wt % |
|---|---|---|
| K | K₂O | 0.18 |
| Na | Na₂O | 1.10 |
| Al | Al₂O₃ | 2.16 |
| Ca | CaO | 25.0 |
| Cr | Cr₂O₃ | 0.35 |
| Cu | CuO | 0.20 |
| Fe | Fe₂O₃ | 4.61 |
| Mg | MgO | 2.22 |
| Mn | MnO₂ | 0.10 |
| Mo | MoO₃ | 0.05 |
| Ni | NiO | 0.15 |
| P | P₂O₅ | 23.5 |
| Si | SiO₂ | 2.89 |
| Zn | ZnO | 12.2 |
| Zr | ZrO₂ | 0.19 |

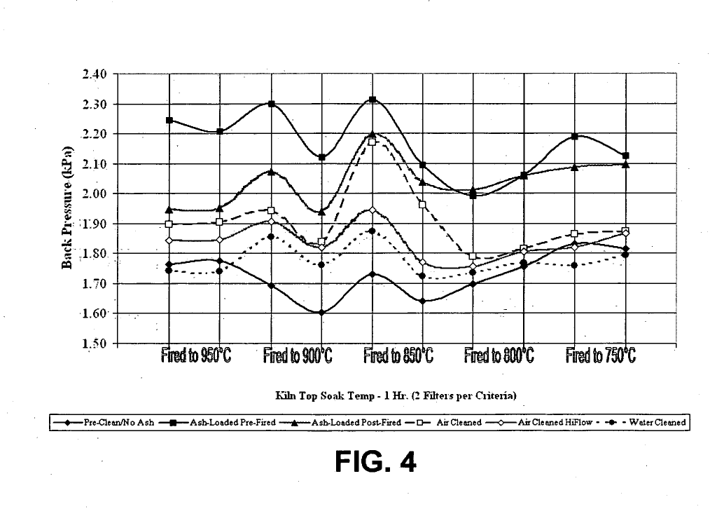

Filters that were tested were Corning Dura Trap® CO filters. Each filter was manually loaded with the ash composition, and then placed in an oven at varying temperatures to “bake” the ash onto the filter, similar to conditions that would occur in actual operation. After 1 hour, the filters were removed from the oven and air-cleaned at 100 psi pressure. The results of baking 10 different ash-coated filters at different temperatures are indicated in FIG. 4. The results indicate that the higher the temperature at which the filters are baked, the greater the ash retention and thus the less effective air-cleaning is.

### EXAMPLE 2

A screening experiment was performed in which a sample of the ash was placed in a beaker and solutions of varying pH (including de-ionized (DI) water) were poured over the ash and into the beaker. Over various periods of time, the beakers were visually observed for color changes to the initially clear solution. The results of varying pH and times are shown in Table 2.

TABLE 2

| Time | pH = 1 | pH = 2 | pH = 3 | pH = 4 | pH = 5 | pH = 6 | DI water | pH = 12 |
|---|---|---|---|---|---|---|---|---|
| 5 min | 3 | 2 | 0 | 0 | 0 | 0 | 0 | 0 |
| 45 min | 5 | 3 | 1 | 0 | 0 | 0 | 0 | 0 |
| 125 min | 5 | 4 | 3 | 0 | 0 | 0 | 0 | 0 |

Maximum color change = 5
No color change = 0

Based on the results shown in Table 2, pH 3 can be effective to break down an ash aggolomerate. A pH of less than 3 is even more effective.

### EXAMPLE 3

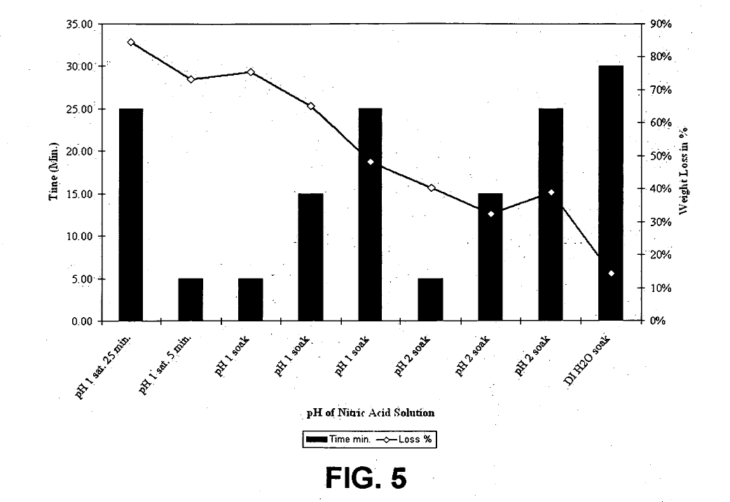

A Corning Dura Trap® CO filter was loaded with ash and then fired at 900° C. for one hour. The fired filter was air-cleaned using 100 psi air. Following air-cleaning, the filter was placed into a container, and a nitric acid solution was poured over the filter (approx. 1500 ml of solution) and soaked for a predetermined period of time. The procedure was performed at pH=1 and pH=3, and using DI water, for varying time periods. After soaking, the filter was water-rinsed. The results are shown in FIG. 5. The figure shows the impact of pH and time on ash removal. Soaking at pH=1 for 5 minutes was sufficient to remove around 80% of the ash that remained after air-cleaning. Additional soaking time did not significantly increase ash removal.

### EXAMPLE 4

A nitric acid solution (pH 1; approximately 2500 ml) was poured over an air-cleaned filter (Corning Dura Trap® CO; diameter 5.66″; length 6″) that had been previously ash coated and fired at 900° C. for one hour. Approximately 1000 ml of the acid solution was absorbed onto the filter. After 5 minutes soaking in the absorbed solution, the filter was rinsed. Ash removal was calculated to be 72.7%.

### EXAMPLE 5

The procedure of Example 4 was repeated, except that the filter containing the absorbed solution was allowed to be soaked for 25 minutes. Ash removal was calculated to be 84.4%.

### EXAMPLE 6

Coated filters were evaluated using the method of Example 4. The filters tested were Corning Dura Trap® CO and Corning Dura Trap® RC filters. The filters were coated with a coating containing a mixture of gamma-alumina and precious metals. The results are shown in Table 3. A loss of coating material was suspected as the cause of the CO filter efficiency results.

TABLE 3

| | Weight | | | | | | |
|---|---|---|---|---|---|---|---|
| | before | Ash | Actual | After | After | Weight | |
| Filter | loading | Tar- | Loading | loading | cleaning | Loss | Efficiency |
| Type | (g) | get | (g) | (g) | (g) | (g) | (%) |
| CO | 1193.11 | 5 g/l | 13.06 | 1206.17 | 1193.6 | 12.57 | 96.3% |
| RC | 1776.4 | 25 g/l | 45.65 | 1822.05 | 1792.12 | 29.93 | 65.6% |
| RC | 1852.2 | 25 g/l | 44.76 | 1896.96 | 1857.04 | 39.92 | 89.2% |
| CO | 1217.8 | 25 g/l | 39.57 | 1257.37 | 1216.99 | 40.38 | 102.1% |

The principles and modes of operation of this invention have been described above with reference to various exemplary and preferred embodiments. As understood by those of skill in the art, the overall invention, as defined by the claims, encompasses other preferred embodiments not specifically enumerated herein.

What is claimed is:

1. A method for removing ash from a filter, comprising:
providing a particulate filter having ash deposited thereon;
contacting the filter containing the ash deposit with an acid composition to remove at least a portion of the ash from the filter; and
treating the acid-contacted filter to remove at least a portion of the acid from the filter.

2. The method of claim 1, wherein the acid composition has a pH of less than or equal to 3.

3. The method of claim 1, wherein the acid-contacted filter is treated by rinsing with a solution to remove at least a portion of the acid and thereby neutralize the filter.

4. The method of claim 1, wherein the ash deposited on the filter is a heat-treated deposit that has been heated at a temperature of at least 700° C.

5. The method of claim 1, wherein the acid composition includes at least one organic or inorganic acid.

6. The method of claim 1, wherein the acid composition contacts the ash deposited filter at a total volume of acid composition to filter of from 0.1:1 to 3:1.

7. The method of claim 1, wherein the acid composition contacts the ash deposited filter for not more than one hour.

8. The method of claim 1, wherein the filter is a ceramic filter comprised of at least one component selected from the group consisting of cordierite, mullite, alumina, zirconium phosphate, silicon carbide, silicon nitride and aluminum titanate.

9. A method for removing ash from a ceramic filter, comprising:
providing a ceramic filter having ash deposited thereon;
contacting the filter containing the ash deposit with an acid composition to remove at least a portion of the ash from the filter, wherein the acid composition has a pH of less than or equal to 3; and
water rinsing the acid contacted filter to remove at least a portion of the acid from the acid contacted filter.

10. The method of claim 9, wherein the ash deposited on the filter is a heat-treated deposit that has been heated at a temperature of at least 700° C.

11. The method of claim 9, wherein the ceramic filter is comprised of at least one component selected from the group consisting of cordierite, mullite, alumina, zirconium phosphate, silicon carbide, silicon nitride and aluminum titanate.

12. The method of claim 9, wherein the water rinsed filter is dried following rinsing.

13. The method of claim 9, wherein the ash deposited filter is contacted with vapor to remove at least a portion of ash contained on the ash deposited filter prior to contacting with the acid composition.

14. The method of claim 9, wherein the acid composition includes at least one organic or inorganic acid.

15. The method of claim 9, wherein the acid composition contacts the ash deposited filter at a total volume of acid composition to filter of from 0.1:1 to 3:1.

16. The method of claim 9, wherein the acid composition contacts the ash deposited filter for not more than one hour.

17. The method of claim 9, wherein the filter containing the ash deposit is provided from an exhaust housing of a diesel engine system.

18. The method of claim 17, wherein the filter containing the ash deposit is provided from an exhaust housing of a diesel engine system after 100,000 miles of operation.

19. A system for removing ash from a filter, comprising:
an acid container for containing an acid composition;
a pump and injection line connected to the acid container;
a housing to hold the filter;
a nozzle extending from the injection line and into the housing, and apertured to spray the acid composition over the filter contained in the housing; and
a collection line for removing the acid solution from the housing.

20. The method of claim 19, wherein the nozzle includes a rotating head.
